(19) United States
(12) Patent Application Publication
(10) Pub. No.: US 2003/0226889 A1
(43) Pub. Date: Dec. 11, 2003

(54) ID card internet locating service

(76) Inventor: James H. Morrison JR., Conifer, CO (US)

Correspondence Address: James H. Morrison, Jr., 27204 Arrowhead Lane, Conifer, CO, 80433, US

(21) Appl. No.: 10/163,287

(22) Filed: Jun. 6, 2002

(51) Int. Cl. G06K 5/00

(52) U.S. Cl. 235/380

(57) ABSTRACT

The ID Card Internet Locating Service (www.locatingme.com) is a internet service which will permit individuals and families to post detailed current location or medical information on a continuous or as needed basis. This information will be stored on a database and will be accessible by use of a access ID number and password. Each member of the family will be issued an Emergency Information Card with basic identification, emergency contact and medical information printed on the card. The card will also have a ID number and password which will permit the holder to access the database to retrieve the most current location and medical information the subscriber has posted.

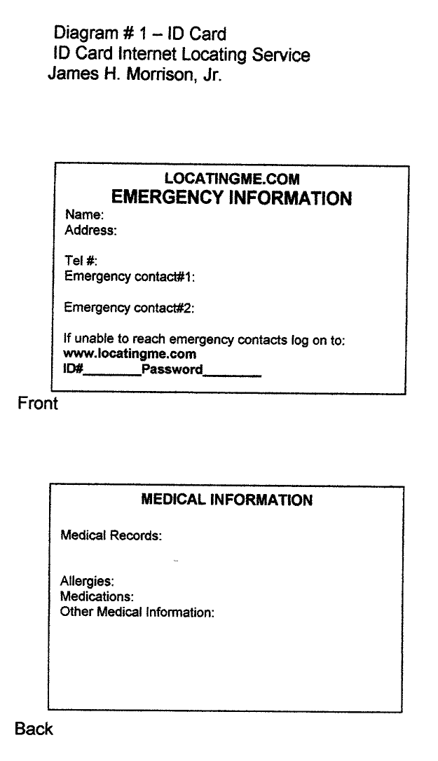

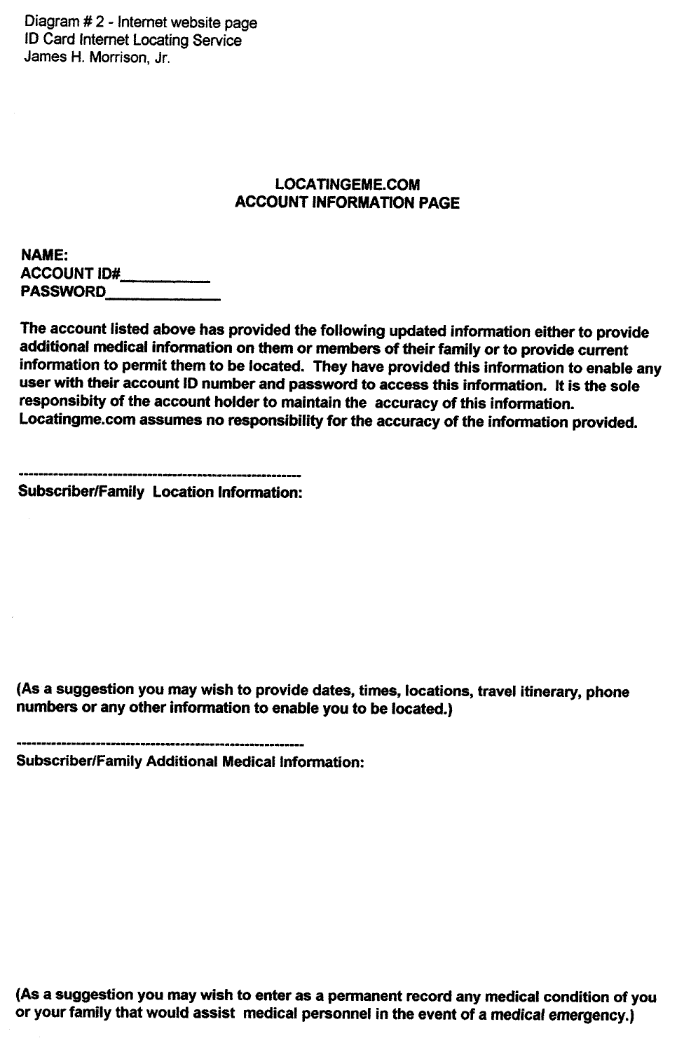

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR COMPUTER PROGRAM LISTING COMPACT DISC APPENDIX

Not Applicable

### BACKGROUND OF THE INVENTION

This invention relates to the ability to locate someone on a continuous basis. Although one might have an ID card with emergency contacts listed, that Information could be out of date when needed most. This invention permits those who must access the information to have the ability to retrieve the most recent information available.

### BRIEF SUMMARY OF THE INVENTION

This service was invented to make it possible to locate people under circumstances where it might not otherwise be possible. By having an ID card with a link to a website where current information can be posted, even if someone is traveling, out of cell phone range, or even out of the country, they can leave detailed information on this website on a continuous basis, so that anyone with access to the ID card(s) issued, can log on to this internet website and using the ID number and password printed on the card, find out the most recent information the subscriber or anyone in their family has entered. ID cards presently used may have emergency contacts listed, but are useless if the intended contact is not available at the number listed on the card.

Another advantage to this invention is that 3^{rd} parties with access to the card can retrieve this information. This might include emergency medical personnel, law enforcement personnel, or caregivers having the ability to locate the listed family member if someone in the family was injured or incapacitated and unable to communicate how to contact their next of kin.

### BRIEF DESCRIPTION OF SEVERAL VIEWS OF THE DRAWING

Drawing #1

Drawing #1 depicts the front and back of the ID card which will be issued to each member of the subscriber's family. Each ID card will be printed with the Information supplied by the subscriber in essentially the format shown. All Members of the family will have a user ID and password printed on their cards. The cards will be credit card size, red with black printing. By logging on to www.locatingme.com, and entering the user ID and password, the user will have access to the most recent information posted by the subscriber or any member of their family (see drawing #2)

Drawing #2

Drawing #2 depicts the format of the actual website page that will be displayed when someone logs on to www.locatingme.com and enters the user ID and password printed on the ID cards. The subscriber or anyone in their family will, through the use of a separate master ID and password (not printed on the card) be able to change or edit the information stored there at any time.

### DETAILED DESCRIPTION OF THE INVENTION

The ID Card Internet Locating Service is an internet based service designed to permit families to store location and medical information for each member of the family on a website database and to be able to change or edit this information at any time. This service is offered on an annual subscription basis.

Each member of the family will be issued their own ID Card (see diagram #1) This card will contain the following information: Name, Address, Phone, Emergency Contact #1 (name and telephone numbers), Emergency Contact #2 (name and telephone numbers) and instructions that if the emergency contacts cannot be reached, the holder should log on to www.locatingme.com, enter the access ID number and password printed on the card, and the holder will be able to access the most recent location or medical information entered in the database by the subscriber or any member of their family. (see diagram #2) The back of the card will be printed with whatever medical information the subscriber wishes to be on the card.

Each member of the family will have the ability to post detailed information on the database such as travel plans, itinerary, or alternate phone numbers and may change these as often as their plans may change to permit their families or anyone with access to their ID number and password to retrieve the most current information in order to be able to reach them.

In addition, 3^{rd} parties, such as emergency medical personnel will have the ability to access both the limited medical information on the card, or access the database for more detailed medical information as well as to access the most current location or contact information to locate family members if they were unable to reach anyone using the emergency telephone numbers printed on the card.

What distinguishes this service from existing emergency cards is the ability of anyone in the family to change or edit their location or medical information and to have that information accessible to anyone with access to the information on the card.

1. What I claim as my invention is an Internet based locating service, which will permit the subscriber or any member of their family to enter, store or edit on a continuous basis, information that would permit them to be located. This could include travel plans, itinerary, phone numbers or any other information that would permit anyone who has access to their website database page (see diagram #2) to retrieve this information.
Each subscriber and member of their family will be issued a personalized ID card (see diagram #1). Each account will have an ID Number and password printed on the card so that anyone with access to the card will be able to retrieve the information stored on their website database page.
